(19) United States
(12) Patent Application Publication
(10) Pub. No.: US 2002/0001103 A1
(43) Pub. Date: Jan. 3, 2002

(54) Method and device for rearranging an electronic document

(76) Inventors: Jean-Jacques Moreau, Rennes (FR); Stephane Amarger, Chaville (FR)

Correspondence Address: FITZPATRICK CELLA HARPER & SCINTO, 30 ROCKEFELLER PLAZA, NEW YORK, NY, 10112, US

(21) Appl. No.: 09/897,035

(22) Filed: Jul. 3, 2001

(30) Foreign Application Priority Data
Jul. 3, 2000 (FR) 0008620

(51) Int. Cl. G06F 15/00

(52) U.S. Cl. 358/1.18; 358/1.1

(57) ABSTRACT

The method of printing an electronic document comprises a step (E1) of constructing groups of recordings of graphical instructions forming an information block of the document, a step (E6, E30-E33) of dividing these groups into a minimum number of sub-groups adapted to be printed respectively on single sheets after enlargement; and a step (E9, E36) of printing the document after enlargement from the main print file (EM F) and related print files.

Use notably for printing a poster.

The present invention concerns a method of rearranging an electronic document with a view to the subsequent processing of this document, such as a printing or display of this document.

It also concerns a rearrangement device adapted to implement the rearrangement method according to the invention.

The present invention also concerns a method and device for printing an electronic document after rearrangement thereof.

The technical field to which the present invention relates is that of the processing of an electronic document created on a computer, which is then printed on a printing device such as a printer, or transmitted by a facsimile machine, or displayed on a screen.

It is particularly well adapted to the printing of a document after enlargement, notably for producing posters or notices.

Thus, when it is wished to print a document in poster mode, that is to say after enlargement, a document is converted for example from an A4 format into a document with an A3 format.

However, the majority of printers do not make it possible to print on A3 format sheets, but only on A4 format sheets.

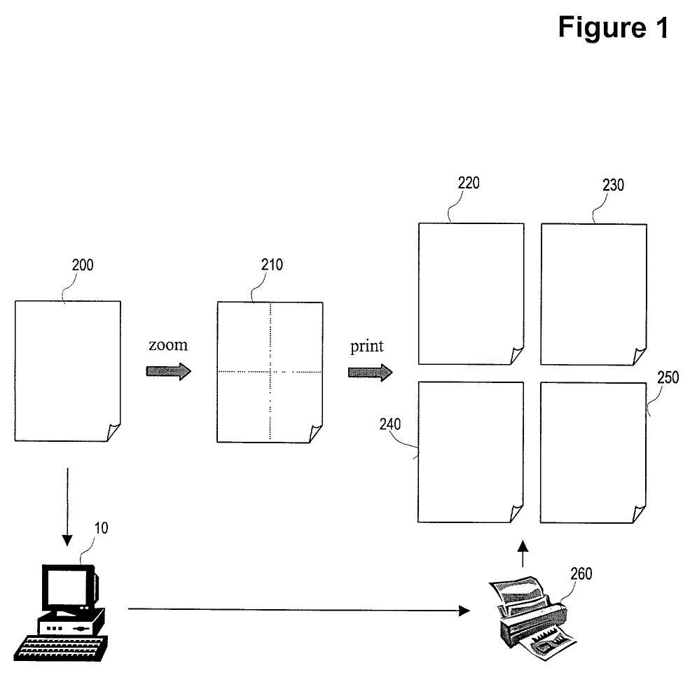

Thus, as illustrated in FIG. 1, the conventional technique of printing a document after enlargement, comprising for example a page 200, consists of virtually dividing the document 200 into four pages 210 in a memory.

Next these pages are printed physically on four sheets 220, 230, 240, 250, by means of a printer 260 connected to a computer 10.

From these four printed sheets 220, 230, 240, 250, the user will be able to effect a collage in order to join these sheets and reconstitute the final poster.

This operation is not simple because notably of the mechanical characteristics of printers.

This is because the contour of each sheet 220, 230, 240, 250 has white margins necessary for printing.

These margins will entail a series of cuts to be made by the user before the collage of the sheets 220, 230, 240, 250, which may give rise to faulty handling and make the collage difficult.

The quality of the final poster will consequently be mediocre.

A similar problem is observed when it is wished to print or display information in an electronic document distributed over several pages of the document.

Such an electronic document may be a graph, of the Gantt graph type, which extends over several pages of the document.

When it is wished to print or display such a document, it is necessary to print several pages or successively display different pages on a screen.

The purpose of the present invention is to resolve the aforementioned drawbacks and to reduce the number of handling operations to be performed on a document in order to reconstitute the information contained in this document.

To this end, the rearrangement method to which the present invention relates makes it possible to rearrange an electronic document with a view to subsequent processing, the electronic document comprising a set of recordings of graphical instructions.

According to the invention, the rearrangement method comprises the following steps:

constructing at least one group of recordings of graphical instructions, a first recording of graphical instructions belonging to a group if there exists at least a second recording of graphical instructions in said group juxtaposing or intersecting the first recording of graphical instructions; and

dividing the group of recordings of graphical instructions into a minimum number of subgroup or subgroups of recordings of graphical instructions, each subgroup of recordings of graphical instructions being adapted to be processed on an entity with a predetermined format.

Thus, for each significant block of information in the document, formed by contiguous recordings of graphical instructions, a division of this block of information into a minimum number of subgroups is effected.

Thus this block of information can be printed on a minimum number of pages, in order notably to reduce the presence of white margins to be cut in order to reconstitute the block of information after printing.

By way of example, this block of information can be an area of text or an image contained in the electronic document and is formed by a group of recordings of graphical instructions, also referred to in the remainder of the description as a segment.

According to a preferred characteristic of the invention, the construction step is implemented independently on each set of recordings of graphical instructions associated respectively with a page of the said electronic document.

Thus, in a conventional system for managing electronic documents on a computer, all the recordings of graphical instructions in the document are distributed in processing files associated respectively with each page of the document.

It thus suffices, during the construction step, to implement this construction step independently on each processing file associated with a page of the document.

Advantageously the rearrangement method comprises, before the dividing step, a step of merging groups of recordings of graphical instructions, two groups of recordings of graphical instructions, belonging respectively to two distinct pages of the electronic document, being merged if they are contiguous.

Thus the rearrangement method according to the invention makes it possible not only to group together the significant blocks of information on the same page of the document, but also group together contiguous blocks of information which belong to different pages in the electronic document.

According to another preferred characteristic of the invention, the rearrangement method also comprises a step of storing each subgroup of recordings of graphical instructions respectively in a related processing file.

Thus, after the rearrangement method, each block of information in the electronic document can be processed independently by virtue of the related processing file.

Advantageously, this rearrangement method also comprises a step of substituting, for each group of recordings of graphical instructions, in a main processing file associated with the electronic document, graphical instructions adapted to represent the geometric envelope of said group.

Thus, in the main processing file, each block of information which is processed separately is masked, in order to replace this block of information by marking its location in the main processing file.

When the document is printed, by virtue of this main processing file, a pattern is produced which indicates the locations of each block of information printed on related sheets.

According to another preferred characteristic of the invention, at the dividing step, each subgroup of recordings of graphical instructions is adapted to be processed on an entity with a predetermined format after enlargement of the electronic document.

The rearrangement method is particularly well adapted to facilitate the processing of an electronic document after enlargement thereof.

This is because each block of information on a page able to be processed on several pages after enlargement of the document can be identified at the construction step, and then be redivided into a minimum number of subgroups of recordings each corresponding to a processing page.

According to another aspect of the invention, a method of printing an electronic document after rearrangement of the document comprises a step of printing the document from the related processing file or files and the main processing file.

The significant blocks of information in the document are thus printed on related sheets from related printing files.

These related sheets are then stuck to the printed sheets from the main printing file of the document in order to reconstitute the document.

In this way a quality document is obtained, requiring fewer handlings on the part of the user in order to reconstitute the document after printing thereof on several sheets of a given format.

According to one advantageous characteristic of the invention, the printing method comprises, before the step of printing each related processing file, the following steps:

analysing the content of each related processing file; and

configuring a printing device, choosing one configuration amongst a set of predetermined configurations, according to the content of each related processing file.

This characteristic makes it possible to adapt the configuration of the printing device to the content of each block of information to be printed.

According to another advantageous characteristic of the invention, at the printing step, the printing device is configured in a draft mode in order to print the main processing file.

Thus the printing device is configured in a minimum mode, normally referred to as draft mode, provided that the main processing file no longer contains anything more than simple graphical instructions.

This is because elaborate graphical instructions, of the image or drawing type, are printed on related sheets from related processing files.

Correlatively, the present invention concerns a device for rearranging an electronic document with a view to subsequent processing, the electronic document comprising a set of recordings of graphical instructions.

This rearrangement device comprises:

means of constructing at least one group of recordings of graphical instructions, a first recording of graphical instructions belonging to a group if there exists at least a second recording of graphical instructions in the said group juxtaposing or intersecting the first recording of graphical instructions; and

means of dividing the group of recordings of graphical instructions into a minimum number of subgroup or groups of recordings of graphical instructions, each subgroup of recordings of graphical instructions being adapted to be processed on an entity with a predetermined format.

According to another aspect of the invention, a device for printing an electronic document comprises means of printing the electronic document from the related processing file or files and the main processing file obtained after rearrangement of the document in accordance with the rearrangement method according to the invention.

These rearrangement and printing devices have advantages and characteristics similar to those of the rearrangement and printing methods according to the invention.

The present invention also concerns a computer comprising means adapted to implement the rearrangement method according to the invention and a printer comprising means adapted to implement the printing method according to the invention.

It relates finally to a computer program which can be read by a computer or microprocessor, comprising portions of software code adapted to implement the rearrangement and/or printing method according to the invention.

Other particularities and advantages of the invention will also emerge from the following description.

In the accompanying drawings, given by way of non-limitative example:

FIG. 1 illustrates a conventional technique for printing a document after enlargement;

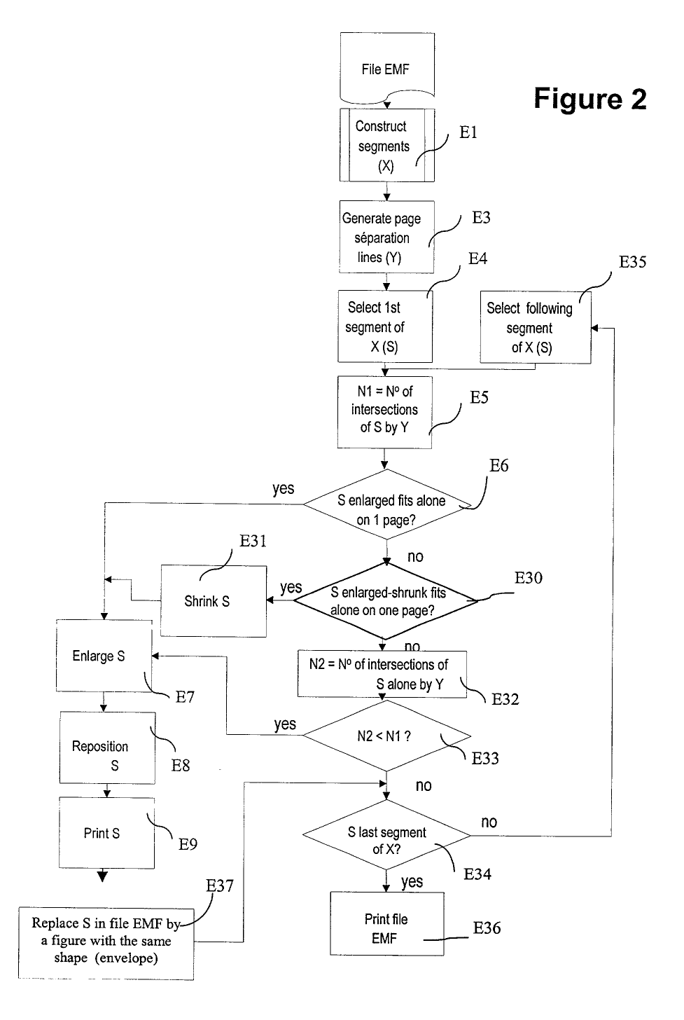

FIG. 2 is an algorithm representing a printing method in a first embodiment of the invention;

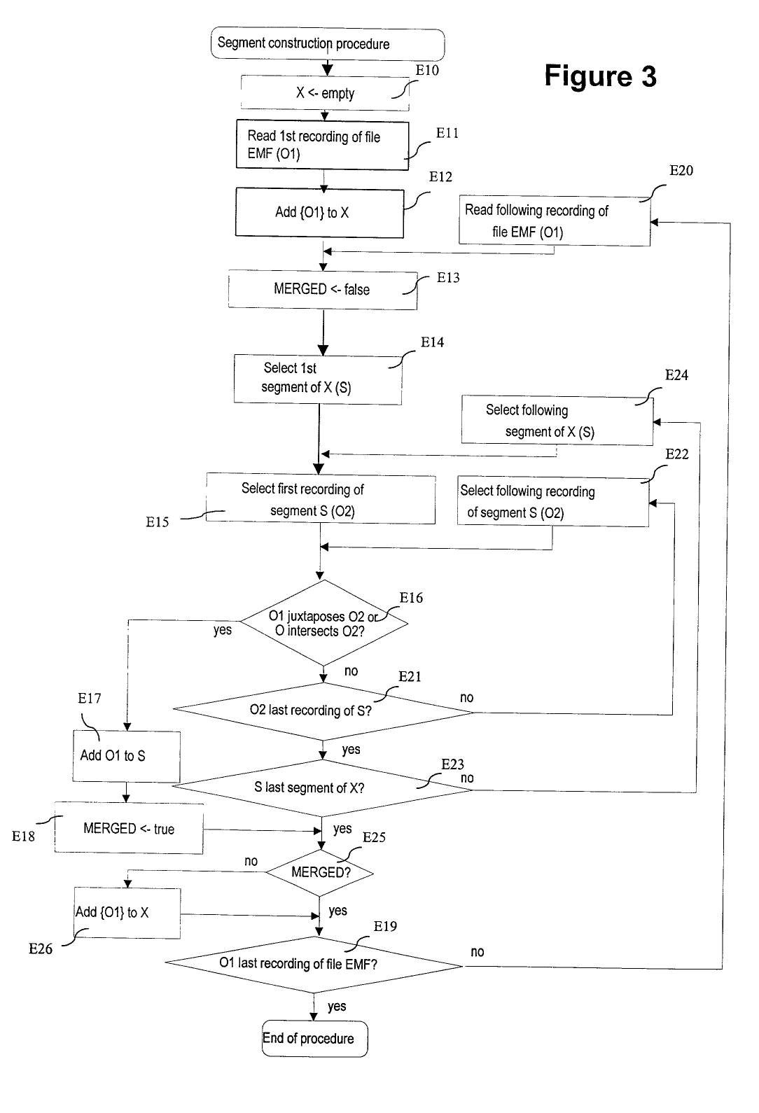

FIG. 3 is an algorithm illustrating a construction step of the printing method according to FIG. 2;

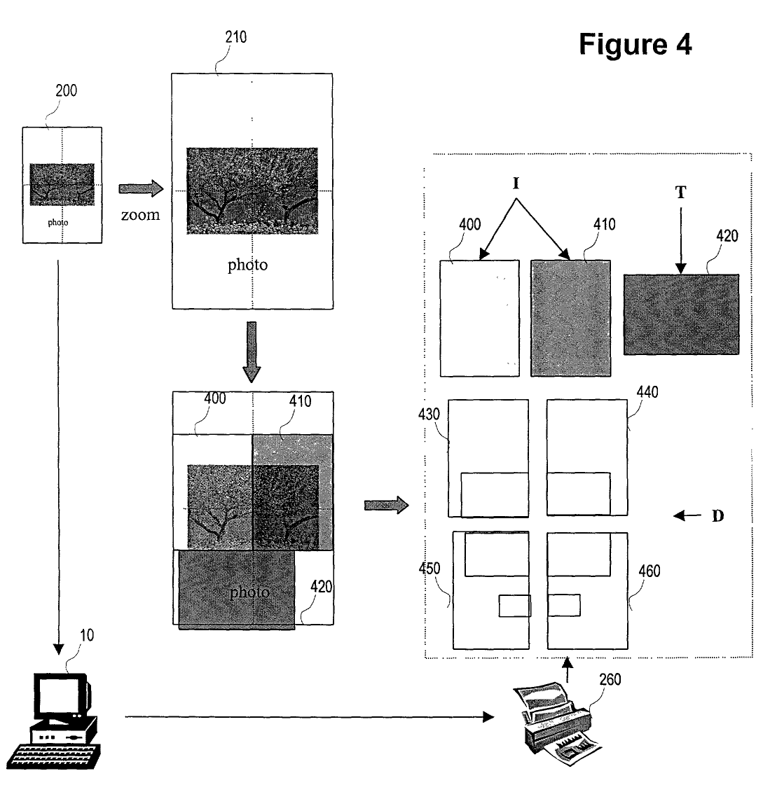

FIG. 4 illustrates schematically the printing method according to the invention implemented on a page of a document;

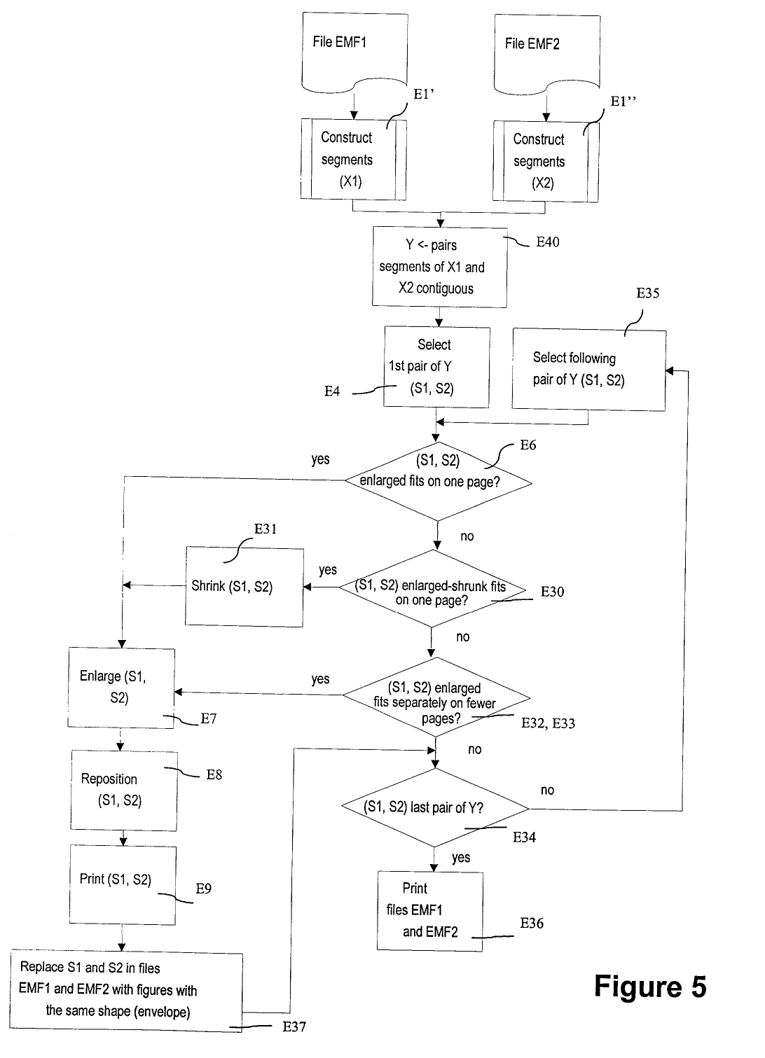

FIG. 5 is an algorithm illustrating a printing method in a second embodiment of the invention; and

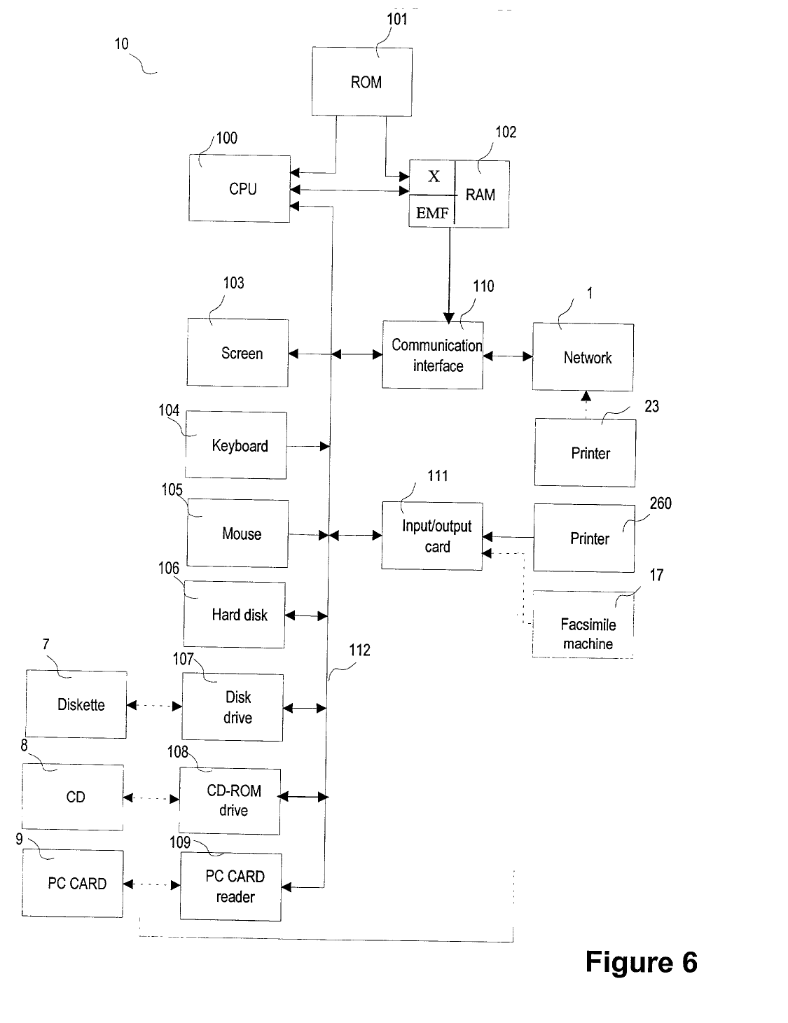

FIG. 6 is a block diagram illustrating a computer adapted to implement the rearrangement method according to the invention.

A description will be given, first of all with reference to FIG. 2, of a method of printing an electronic document after enlargement. In this first embodiment of the invention, the electronic document contains a single page 200, created for example on a computer 10 as illustrated in FIG. 1.

This page 200 is created in an initial format, typically in an A4 format.

Conventionally, when it is wished to print such a page in a document, the content of this page is converted into a series of graphical instructions which are recorded in a print file.

Thus, in Windows for example, such a print file, also referred to as an EMF file or Enhanced Meta File, is created when the user requests printing of the document.

This EMF print file thus comprises the recordings of graphical instructions for printing the page 200 of the document.

Each graphical instruction corresponds to an elementary graphical operation, for example “draw a rectangle” or “draw a circle”, associated with spatial coordinates for determining the position and dimensions respectively of the rectangle or of the circle on the print sheet.

After printing of the document, first of all the document will be rearranged, and notably all the blocks of information existing in the page 200 will be determined from this EMF print file.

For this purpose, a construction step E1 is implemented.

This construction step E1 consists of constructing one or more groups of graphical instructions, referred to in the remainder of the description as segments S.

This step of constructing segments S is illustrated in more detail in FIG. 3.

In an initialisation step E10 an empty set X will be considered, comprising all the segments constructed in the page 200.

A reading step E11 reads a first recording of graphical instructions O1 in the EMF print file associated with the page 200.

This first recording of graphical instructions O1 is added to the set X in an adding step E12.

An indicator MERGED is also initialised to the value “false” in an initialisation step E13.

A selection step E14 next selects a first segment S of the set X.

Next, a second selection step E15 selects the first recording O2 of this first segment S.

A test step E16 determines whether the first recording O1 juxtaposes or intersects the first recording O2 of the first segment S of the set This test can be implemented from coordinates of each recording of graphical instructions O1, O2 stored in the EMF print file.

It is thus determined whether there is an intersection of graphical instructions O1, O2 or whether these graphical instructions are close to each other.

Consider for example two rectangles R1 and R2.

For each of these rectangles, the graphical instructions stored in the EMF print file are of the following type:

R1=(x1, y1, w1, h1) and R2=(x2, y2, w2, h2) where the pair (x, y) defines the bottom left-hand corner of the rectangle; w defines the length of the rectangle in a first direction; and h defines the height of the rectangle in a second direction of the plane.

There is an intersection between the two rectangles R1 and R2 if there is a point (a, b) on the rectangle R1 such that this point (a, b) also belongs to the rectangle R2.

It is known that a point (a, b) belongs to a rectangle if and only if:

x<a<x+w and

y<b<y+h.

Likewise, two rectangles R1 and R2 are close to each other if there is a point (a, b) in the rectangle R1 such that the intersection of the rectangle R2 and a circle C, having as its centre the point (a, b) and a small radius r, is not empty.

The condition for a point (c, d) to belong to a rectangle is set out above.

In addition, this point (c, d) belongs to the circle C (a, b, r) if and only if:

c=a+ρ sin α and d=b+ρ cos α where

0≦α<2π and 0≦ρ<r

These primitives (intersections, juxtapositions) are generally implemented by graphical libraries of the GDI type in Windows®.

If the test of step E16 is positive, the first recording O1 is added to the first segment S of the set X in a step E17.

The indicator MERGED is then set to the value “true” in an update step E18, and then a test step E19 determines whether the first recording O1 is the last recording of the EMF print file.

In the negative, a following recording of the EMF print file is considered in a step E20 and all of steps E13 to E16 are reiterated for this following recording.

On the other hand, if at the end of the test step E16 the recordings of graphical instructions O1, O2 are not contiguous, it is checked in a test step E21 whether the first recording O2 of the first segment S is the last recording of this segment S.

In the negative, the following recording of the first segment S is selected in a step E22 and all of steps E16 to E21 are reiterated.

Otherwise, if at the end of the test step E21 the first recording O2 is the last recording of the first segment S, it is checked in a test step E23 whether the first segment S is the last segment of the set X.

In the negative, the following segment of the set X is selected in a selection step E24 and steps E15 to E23 are reiterated in order to determine whether the first recording O1 of the EMF print file belongs to this following segment.

If at the end of the test step E23 the first segment S is the last segment of the set X, the value of the indicator MERGED is tested in a test step E25.

This value of the indicator having remained at the value “false” initialised at step E13, a step E26 adds the first recording O1 of the EMF print file to the set X, that is to say the recording O1 thus forms a segment of the set X.

Next, in the steps of testing E19 and reading E20, the following recording of the EMF file is considered if such exists.

Thus all the recordings of the EMF print file are analysed one by one up to the end of this file.

Consequently a set X of segments S is constructed, each segment S corresponding to a block of information of the page 200 to be printed.

The blocks of information can be blocks of text, blocks of images or blocks of drawings.

Thus, as illustrated in FIG. 4, the page 200 can include for example a photograph associated with a block of text. This page 200 therefore contains two segments.

As illustrated in the general algorithm in FIG. 2, after having constructed these segments S, page separation lines are generated in a step E3.

This generation of notional lines makes it possible, as illustrated in FIG. 4, to divide the page 200 into four notional pages 210.

Here the two segments of the page 200, that is to say the photograph and the text, are divided by notional lines. They are therefore intended to be printed on several sheets when a conventional printing technique is used.

More precisely, the text would be printed on two sheets and the photograph on four sheets.

Next, in a selection step E4, a first segment S of the set X is selected.

In a calculation step E5 the number N1 of divisions of this segment S by page separation lines is determined.

Next, in a test step E6, it is checked whether this segment S fits on a page after enlargement.

In the affirmative, an enlargement step E7 is implemented and then this first segment S is if necessary repositioned in the plane in a positioning step E8 before being printed in a printing step E9.

Such is the case here with the text of the page 200 in FIG. 4, which can, after enlargement, be printed on a single sheet 420. This text is also positioned in landscape mode in order to be printed in the width of the sheet 420.

On the other hand, if at the end of the test step E6 the enlarged segment S fits on two sheets, an enlargement followed by a slight reduction is implemented in a test step E30 in order to check whether the segment S thus obtained also fits on a single sheet.

The reduction used can be around 5%.

At the end of this test step E30, the segment S is reduced in a step E31 and the steps of enlargement E7, positioning E8 and printing E9 are reiterated on it in order to print this segment on a separate related sheet.

If the segment S, even after slight reduction, does not fit on a single sheet, it is checked whether the segment S after enlargement fits on a number N2 of sheets less than the number N1 of sheets necessary for printing the segment without rearrangement of the document.

For this purpose, in a step E32, the minimum number N2 of divisions of the segment S by page separation lines Y is determined.

In a comparison step E33, this minimum number N2 is compared with the number N1 of cuts determined at step E5.

If this minimum number N2 is strictly less than the number of cuts N1, steps E7 to E9 are also reiterated on the segment S in order to print the latter on several sheets. Here the photograph is thus printed on two related sheets 400 and 410.

Otherwise, if the segment S relates to a number of sheets equal to the number of sheets necessary for printing the document after enlargement, this segment S is printed in a conventional manner.

Such is the case here if a segment S can be printed only on four sheets.

In a test step E34, it is checked whether the first segment S is the last segment of the set X and, in the negative, the following segment of the set X is selected in a reading step E35 and all the steps of the method illustrated in FIG. 2 are reiterated on this following segment.

Finally, when all the segments of the set X have been examined, the EMF print file associated with the page 200 is printed in a printing step E36.

When one of the segments S must be printed separately during the printing step E9, in practice the recordings of graphical instructions associated with this segment S are stored in a related printing file from which the steps of enlargement E7, repositioning E8 and printing E9 are implemented.

In addition, preferably a substitution step E37 is implemented in the main EMF print file associated with the page 200 in order to replace each group of recordings of graphical instructions, forming a segment X printed separately at the printing step E9, with a set of graphical instructions adapted to represent the geometric envelope of this segment S.

In order to replace a group of recordings of graphical instructions with its geometric envelope, the following procedure is followed, according to the type of graphical instruction:

if it is a case of a text, this is replaced in a known manner with a rectangle, in which the text is entered, corresponding to its bounding box;

if the graphical instruction to be substituted is a graphic proper, the background colour is changed so as to make this background white and the contour of the graphic is drawn in dotted lines.

If it is a case of a rectangular-shaped image, the position of this image, its width and its height are read in the EMF print file. This image is replaced with a rectangle with a white background and a contour in dotted lines, with the same position, the same width and the same height;

if the image is different in shape, a practical way of substituting this consists first of all of replacing all the switched-on pixels in this image with black pixels.

Next all these pixels are analysed in order to temporarily store the pixels of the image having a number of adjacent pixels greater than or equal to eight.

This storage step consists in fact of storing all the pixels of the image apart from those defining the contour of this image.

All the previously stored pixels are switched off so that the EMF file now contains only the switched-on pixels corresponding to the contour of the image.

Thus, as illustrated in FIG. 4, the photo and the text printed separately are replaced in the main document with rectangles representing the contour of the photograph and of the text.

Thus, during the step E36 of printing the main EMF print file, sheets 430, 440, 450, 460 illustrating the pattern of the document, that is to say illustrating the contours of the blocks of information printed separately, are obtained at the output of the printer. These contours then facilitate the positioning of the blocks of information after division of the related sheets 400, 410,420.

Preferably, during the step E9 of printing each segment S of the set X, the content of each related print file containing the graphical instructions associated with the segment S is analysed and the printing device, such as the printer 260, is configured choosing a configuration mode amongst a set of predetermined configurations, according to the content of each related print file.

Thus it is possible to modify and adapt the configuration of the printer 260 to the content of the file, for example to choose a configuration in image mode I in order to print photographs and a configuration in text mode T when the segment S contains only text.

Likewise, during the step E36 of printing the EMF print file of the document, the printing device can be configured in a draft mode D since this EMF print file now contains only contour graphical instructions.

Here the sheets 400 and 410 are printed in image mode 1, the sheet 420 in text mode T and the sheets 430,440,450 and 460 in draft mode D.

FIG. 5 illustrates, by way of variant, the printing method according to the invention applied to a document comprising several pages, here for example two pages.

The printing method is substantially identical to the one described previously with reference to FIG. 2 and the analogous steps have identical references and will not be described again.

The document comprising two pages, two separate print files EMF1 and EMF2 make it possible to store the recordings of graphical instructions associated with each of these pages of the document.

Construction steps E1′ and E1″ are implemented separately, on each of the print files EMF1, EMF2.

Thus, as described previously with reference to FIG. 3, two sets X1 and X2 are obtained, containing all the segments associated with each of the pages of the document.

In a merger step E40, the pairs of segments S1, S2 belonging respectively to the sets X1 and X2 are grouped together in a set Y, these segments S1, S2 being contiguous.

Thus in the set Y the segments S1, S2 belonging to two distinct pages of the document and which are intended to be disposed alongside each other after printing of the two pages are selected.

For all the pairs of segments S1, S2 of the set Y, all of steps E4 to E9 and E30 to E37 as described above with reference to FIG. 2 are reiterated, applying these processing steps to the merged segments S1, S2.

It is thus possible, for each pair of segments SI, S2, to print the latter on separate related sheets, using a minimum number of sheets necessary for printing these segments S1, S2.

Although here an embodiment has been described in which the document is enlarged, the method of rearrangement before printing can also be applied when the document is printed in its initial format, in order to separately print the contiguous documents S1, S2 belonging respectively to two distinct pages of the document.

The method according to the invention thus optimises the number of pages necessary for printing blocks of information of a document and avoids unnecessary divisions on the printed sheets in order to reconstitute the document.

A description will now be given, with reference to FIG. 6, of a printing device adapted to implement the rearrangement and printing methods according to the invention.

Here, all the means for implementing the rearrangement method according to the invention are incorporated in a computer 10 and the means for effecting the printing proper are incorporated in a printer 260.

Naturally the rearrangement device could possibly be incorporated in the printer 260, or even a facsimile machine 17.

The rearrangement device for implementing the invention comprises means of constructing segments from a document, means of dividing these segments in order to position them on a minimum number of related sheets, means of merging contiguous segments and means of storing these segments in related print files.

It also has means of substituting, in the print file, for graphical instructions relating to a segment, graphical instructions adapted to represent the geometric envelope of this segment.

The print document has means of printing the document from related print files and the main print file.

It also has means of configuring the printer 260 according to the content of the print file to be printed.

Apart from the print means proper which are incorporated in the printer 260, all the means of the rearrangement and printing device are here incorporated in the computer 10, and more precisely in the microprocessor 100.

A read only memory 101 or ROM is adapted to store the computer program in order to implement the rearrangement and printing methods according to the invention, and a random access memory 102 is adapted to store in different registers the variables modified during the execution of these programs.

By way of example, the random access memory 102 or RAM memory contains registers for storing the set X of segments constructed in the document, the main print file EMF and the related print files.

This computer 10, as illustrated in FIG. 6, is thus connected to a printer 260 by means of an input/output card 111.

It has a communication interface 110 which enables it to be connected to a communication network 1.

If necessary, a printer 23 can be connected to the computer 10 by means of the communication network 1.

The printing of the document for implementing the print method according to the invention can in a similar fashion be performed on the printer 23.

The computer 10 also has a storage means 106, such as a hard disk.

It also has a disk drive 107, a CD-ROM drive 108 and a computer card (also referred to as a PCMCIA card) reader 109.

A diskette 7, a CD-ROM 8 or PC-CARD 9, as well as the hard disk 106, can contain documents to be printed in accordance with the invention, as well as the code of the invention which, once read by the computer 10, will be stored in the disk 106.

According to a variant, the program enabling the computer 10 to implement the invention can be stored in read only memory 101.

In a second variant, the program can be received and stored in an identical fashion by means of the communication network 1.

The computer 10 also comprises a screen 103 for displaying the documents to be printed, or serving as an interface with the user.

The method of rearranging the document can also be implemented on the computer 10 in order to display the document on the screen 103, each segment being divided in order to be displayed on the screen 103 in the predetermined format.

In addition, the user can modify the documents by means of the keyboard 104 or a mouse 105 or any other means.

The central unit or microprocessor 100 will execute the instructions relating to the implementation of the invention.

On powering up, the programs and methods relating to the invention stored in one of the non-volatile memories, for example the read only memory 101, are transferred into the random access memory 102, which will then contain the executable code of the invention as well as the variables necessary for implementing the invention.

A communication bus 112 affords communication between the different sub-elements of the computer 10 or the elements linked to this computer.

The representation of the bus 112 is not limitative and notably the microprocessor 100 is able to communicate instructions to all sub-elements, directly or by means of another sub-element of the computer 10.

Naturally many modifications can be made to the example embodiments described above without departing from the scope of the invention.

Thus, as illustrated in FIG. 6, the printing of the document could be implemented from a facsimile machine 17 connected to the computer 10 by means of the input/output card 111.

1. Method of rearranging an electronic document (200) with a view to subsequent processing, the electronic document comprising a set of recordings of graphical instructions (O1, O2), characterised in that it includes the following steps:
constructing (E1) at least one group (S) of recordings of graphical instructions, a first recording of graphical instructions (O1) belonging to a group (S) if there exists at least a second recording of graphical instructions (O2) in said group (S) juxtaposing or intersecting the first recording of graphical instructions (O1); and
dividing (E6, E30, E33) the group of recordings of graphical instructions (S) into a minimum number of subgroup or subgroups of recordings of graphical instructions, each subgroup of recordings of graphical instructions being adapted to be processed on an entity with a predetermined format.

2. Rearrangement method according to claim 1, characterised in that the construction step (E1′, E1″) is implemented independently on each set of recordings of graphical instructions associated respectively with a page of said electronic document (200).

3. Rearrangement method according to claim 2, characterised in that it comprises, before the dividing step, a step (E40) of merging groups of recordings of graphical instructions, two groups of recordings of graphical instructions (S1, S2), belonging respectively to two distinct pages of the electronic document, being merged if they are contiguous.

4. Rearrangement method according to one of claims 1 to 3, characterised in that it also comprises a step of storing each subgroup of recordings of graphical instructions respectively in a related processing file.

5. Rearrangement method according to claim 4, characterised in that it also comprises a step of substituting, for each group of recordings of graphical instructions (S; S1, S2) in a main processing file (EMF; EMF1, EMF2) associated with said electronic document, graphical instructions adapted to represent the geometric envelope of said group (S; S1, S2).

6. Rearrangement method according to one of claims 1 to 5, characterised in that, at the dividing step, each subgroup of recordings of graphical instructions is adapted to be processed on an entity with a predetermined format after enlargement of the electronic document.

7. Method of printing an electronic document (200) after rearrangement of the document by means of the rearrangement method according to one of claims 4 or 5, characterised in that it comprises a step (E9, E36) of printing the document from the related processing file or files and the main processing file; (EMF; EMF1, EMF2).

8. Printing method according to claim 7, characterised in that it comprises, before the step (E9) of printing each related processing file, the following steps:
analysing the content of each related processing file; and
configuring a printing device (260), choosing one configuration amongst a set of predetermined configurations, according to the content of each related processing file.

9. Printing method according to one of claims 7 or 8, characterised in that, at the printing step (E36), the printing device (260) is configured in a draft mode (D) in order to print the main processing file (EMF; EMF1, EMF2).

10. Device for rearranging an electronic document (200) with a view to subsequent processing, the electronic document comprising a set of recordings of graphical instructions (O1, O2), characterised in that it comprises:
means (100, 101, 102) of constructing at least one group (S) of recordings of graphical instructions, a first recording of graphical instructions (O1) belonging to a group (S) if there exists at least a second recording of graphical instructions (O2) in said group (S) juxtaposing or intersecting the first recording of graphical instructions (O1); and
means (100, 101, 102) of dividing the group of recordings of graphical instructions (S) into a minimum number of subgroup or groups of recordings of graphical instructions, each subgroup of recordings of graphical instructions being adapted to be processed on an entity with a predetermined format.

11. Rearrangement device according to claim 10, characterised in that it comprises means (100, 101, 102) of merging groups of recordings of graphical instructions, two groups of recordings of graphical instructions (S1, S2), belonging respectively to two distinct pages of the electronic document (200), being merged if they are contiguous.

12. Rearrangement device according to one of claims 10 or 11, characterised in that it also comprises means of storing each subgroup of recordings of graphical instructions respectively in a related processing file.

13. Rearrangement device according to one of claims 10 or 12, characterised in that it also comprises means of substituting, for each group of recordings of graphical instructions (S; S1, S2), in a main processing file (EMF; EMF1, EMF2) associated with said electronic document (200), graphical instructions adapted to represent the geometric envelope of said group (S; S1, S2).

14. Device for printing an electronic document (200) after rearrangement of the document by means of the rearrangement method according to one of claims 4 or 5, characterised in that it comprises means of printing (260) the document (200) from the related processing file or files and the main processing file (EMF; EMF1, EMF2).

15. Printing device according to claim 14, characterised in that it also comprises:
means (100, 101, 102) of analysing the content of each related processing file; and
configuration means (100, 101, 102) adapted to choose a configuration amongst a set of predetermined configurations (I, T, D), according to the content of each related processing file.

16. Printing device according to one of claims 14 or 15, characterised in that it comprises configuration means (100, 101, 102) adapted to choose a configuration in a draft mode (D) for printing the main processing file (EMF; EMF1, EMF2).

17. Rearrangement device according to one of claims 10 to 13, characterised in that it is incorporated in a system comprising:
at least one microprocessor (100);
a read only memory (101) adapted to store a program for rearranging a document; and
a random access memory (102) containing registers adapted to store the variables modified during the execution of this program.

18. Computer, characterised in that it comprises means adapted to implement the rearrangement method according to one of claims 1 to 6.

19. Printer, characterised in that it comprises means adapted to implement the rearrangement method according to one of claims 1 to 6.

20. Printer, characterised in that it comprises means adapted to implement the printing method according to one of claims 7 to 9.

21. Computer program, readable by a microprocessor, comprising portions of software code adapted to implement the rearrangement method according to any one of claims 1 to 6.

22. Computer program, readable by a microprocessor, comprising portions of software code adapted to implement the printing method according to any one of claims 7 to 9.
